(19) United States
(12) Patent Application Publication
(10) Pub. No.: US 2007/0071179 A1
(43) Pub. Date: Mar. 29, 2007

(54) Server apparatus

(75) Inventors: Shigeru Fukazawa, Hachioji-shi (JP); Yasumasa Sasaki, Tachikawa-shi (JP); Koji Shima, Sagamihara-shi (JP); Fumikazu Matsukawa, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Toshiba America Information Systems, Inc.

(21) Appl. No.: 11/474,181

(22) Filed: Jun. 23, 2006

(30) Foreign Application Priority Data
Jun. 30, 2005 (JP) 2005-191208

(51) Int. Cl. H04M 3/08; H04M 3/22; H04M 1/24

(52) U.S. Cl. 379/32.01

(57) ABSTRACT

According to one embodiment, a server apparatus includes a detector which detects a failure of communication between the telephone exchange apparatus and the server apparatus, a restoring unit which restores a connection between the telephone exchange apparatus and the server apparatus by recovering the failure based on a detection result of the detector, an acquiring unit which acquires state information regarding an operation of the plurality of telephone terminals from the telephone exchange apparatus, after the connection between the telephone exchange apparatus and the server apparatus is restored, and a controller which performs data communication between first and second data terminals associated with first and second telephone terminals between which a call is made, based on the state information acquired by the acquiring unit.

### CROSS-REFERENCE TO RELATED APPLICATIONS

This application is based upon and claims the benefit of priority from Japanese Patent Application No. 2005-191208, filed Jun. 30, 2005, the entire contents of which are incorporated herein by reference.

### BACKGROUND

1. Field

One embodiment of the invention relates to a server apparatus of a visual communication system, which is connected to a telephone exchange through a communication channel to process video signals and computer data as well as speech signals and associate data communication between data terminals connected to the server apparatus with a call connection between telephone terminals.

2. Description of the Related Art

Telephone exchanges such as a private branch exchange (PBX) and a key telephone apparatus are used in offices and places of business. The telephone exchanges have telephones as extension terminals and their exchange connection allows a call between the extension terminals and an external communication network such as a public network and between the extension terminals.

A computer telephony integration (CTI) system has recently been proposed in which a videophone terminal and a data terminal such as a personal computer are connected to a telephone exchange directly or via a server (see Jpn. Pat. Appln. KOKAI Publication No. 2000-174925, for example).

It is fully expected that a failure will occur between a telephone exchange and a computer such as a server and a data terminal in the CTI system described above. The telephone exchange and the computer periodically confirm by an inquiry signal that they are operating. If a failure is detected, the internal conditions of the computer are initialized to repeat a process of restoring a communication link between the telephone exchange and the computer. When the communication link is restored, the function of the system can be fulfilled in the same manner as before the detection of the failure in accordance with a call state that has varied from the time of the restoration.

In a parallel system of a telephone exchange and a server, it is desired that data communication between data terminals be associated with a call state of a telephone terminal to provide a videoconference and the like. This system is called a visual communication system. If, however, the visual communication system is applied to the above CTI system, a data terminal has to control visual communication in accordance with a call state of a telephone terminal and thus its control burden increases. Therefore, no general-purpose computers can be used for the data terminal, but the entire system will increase in cost.

In order to achieve the above visual communication system, it is necessary to take measures against the occurrence of a failure. If the user of a telephone terminal is communicating at the time of failure recovery, a session between data terminals associated with the telephone terminal cannot be reconstructed unless the data terminal or VCS server receives a call information event from a telephone exchange. The telephone terminal cannot receive a call information event from the telephone exchange unless a call state of the telephone terminal varies.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic diagram of a visual communication system according to an embodiment of the present invention;

FIG. 2 is a block diagram of a functional structure of a VCS server in the visual communication system according to the embodiment of the present invention;

FIG. 3 is a diagram showing an example of contents stored in a connection information management table managed by a call connection management unit of the VCS server shown in FIG. 2;

FIG. 4 is a diagram showing an example of contents stored in an extension terminal and visual client (VC) association table managed by a client session control unit of the VCS server shown in FIG. 2;

FIG. 5 is a diagram showing an example of contents stored in a session information management table managed by the client session control unit of the VCS server shown in FIG. 2;

FIG. 6 is a flowchart showing a procedure for controlling the VCS server when a failure is detected and recovered in the visual communication system according to the embodiment of the present invention; and

FIG. 7 is a schematic sequence chart showing transmission and reception of information between extension terminals, a main device, a VCS server and data terminals when visual communication is carried out in the visual communication system according to the embodiment of the present invention.

### DETAILED DESCRIPTION

Various embodiments according to the invention will be described hereinafter with reference to the accompanying drawings. In general, according to one embodiment of the invention, a server apparatus which receives call information indicative of a call connection state of a plurality of telephone terminals from a telephone exchange apparatus that performs an exchange process between the plurality of telephone terminals, and associates data communication of data terminals associated with the plurality of telephone terminals with the call connection state, comprising: a detector which detects a failure of communication between the telephone exchange apparatus and the server apparatus; a restoring unit which restores a connection between the telephone exchange apparatus and the server apparatus by recovering the failure based on a detection result of the detector; an acquiring unit which acquires state information regarding an operation of the plurality of telephone terminals from the telephone exchange, after the connection between the telephone exchange and the server apparatus is restored; and a controller which performs data communication between first and second data terminals associated with first and second telephone terminals between which a call is made, based on the state information acquired by the acquiring unit.

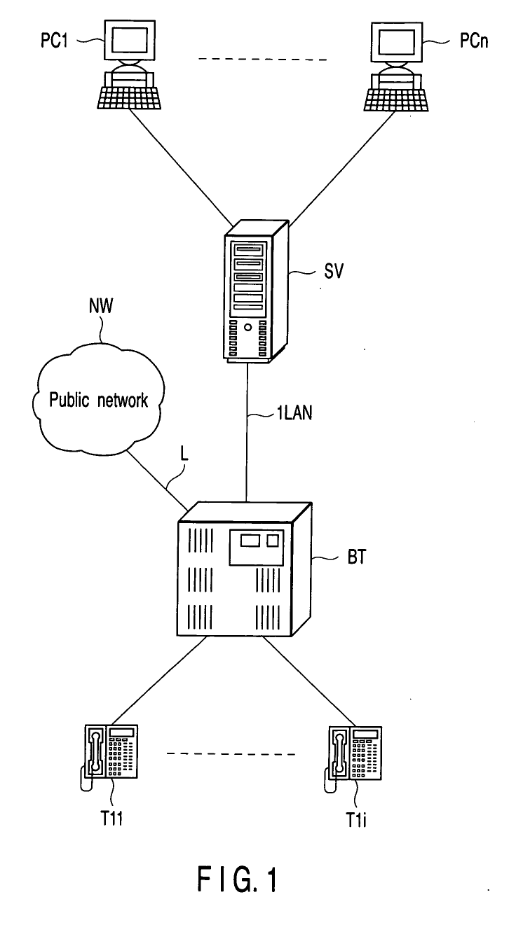

FIG. 1 is a schematic diagram of a visual communication system according to the embodiment of the present invention.

As shown in FIG. 1, the visual communication system includes a main device BT and a visual communication system (VCS) server SV. The main device BT and VCS server SV are connected to each other via a local area network (LAN) 1.

The main device BT has extension terminals T11 to T1i through extensions. The main device BT is connected to a public network NW via a central office line (L). The main device BT performs an exchange process between the extension terminals T11 to T1i or between the extension terminals T11 to T1i and the public network NW.

The VCS server SV has a plurality of data terminals PC1 to PCn through an IP network. The data terminals PC1 to PCn are configured by general-purpose personal computers and associated with the extension terminals T11 to T1i, respectively.

The VCS server SV carries out additional functions of the main device BT. For example, it processes media information such as image data.

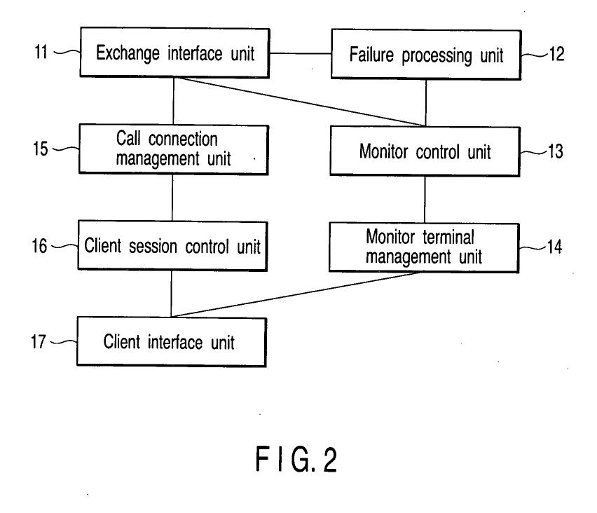

FIG. 2 is a block diagram of a functional structure of the VCS server SV described above.

The VCS server SV includes an exchange interface unit 11, a failure processing unit 12, a monitor control unit 13, a monitor terminal management unit 14, a call connection management unit 15, a client session control unit 16 and a client interface unit 17.

The exchange interface unit 11 periodically transmits a monitor signal to the main device BT and receives its response signal from the main device BT. When the response signal is cut off, the exchange interface unit 11 determines that a failure occurs in a communication link between the unit 11 and the main device BT and notifies the failure processing unit 12 of the occurrence of the failure.

When the failure occurs, the failure processing unit 12 performs a necessary initialization process and reestablishes a communication link. When the communication link is done, the unit 12 requests the monitor control unit 13 to resume monitoring.

At the request of the failure processing unit 12, the monitor control unit 13 requests the main device BT to notify the unit 13 of the states of the extension terminals T11 to T1i whose monitoring is managed by the monitor terminal management unit 14.

The monitor terminal management unit 14 manages the data terminals PC1 to PCn registered in the system and requests the monitor control unit 13 to start monitoring each time a data terminal is registered.

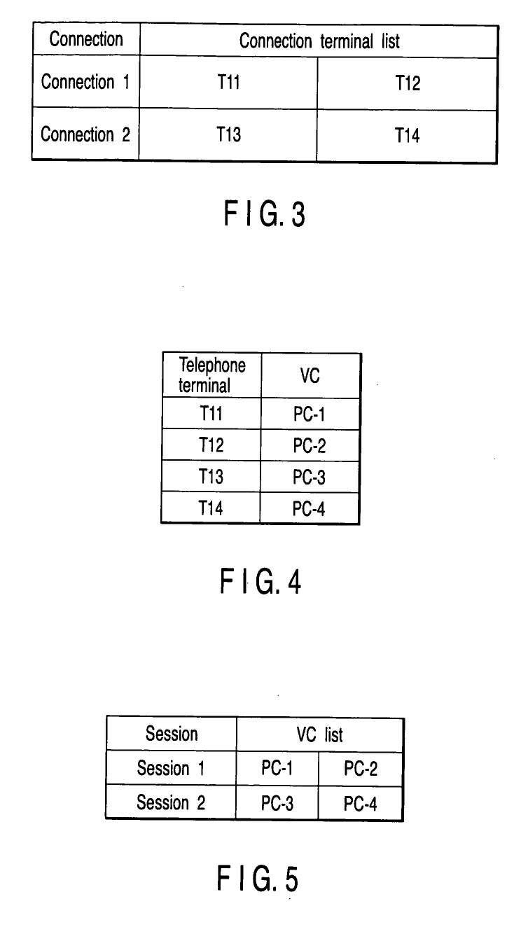

The call connection management unit 15 interprets a call information event indicating variations in the states of extension terminals T11 to T1i which are sent from the main device BT. Thus, the unit 15 manages, for example, telephone terminals T11, T12, T13 and T14 whose communication link is established on a connection information management table as shown in FIG. 3.

The client session control unit 16 stores an extension terminal and visual client (VC) association table shown in FIG. 4 and a session information management table shown in FIG. 5. The unit 16 controls a session between data terminals PC1 to PC4 associated with telephone terminals T11 to T14 whose communication link is established by the connection management unit 15. When the session is established, the unit 16 updates the contents stored in the session information management table.

The client interface unit 17 interfaces with the data terminals PC1 to PCn.

An operation of the visual communication system so configured will be described below.

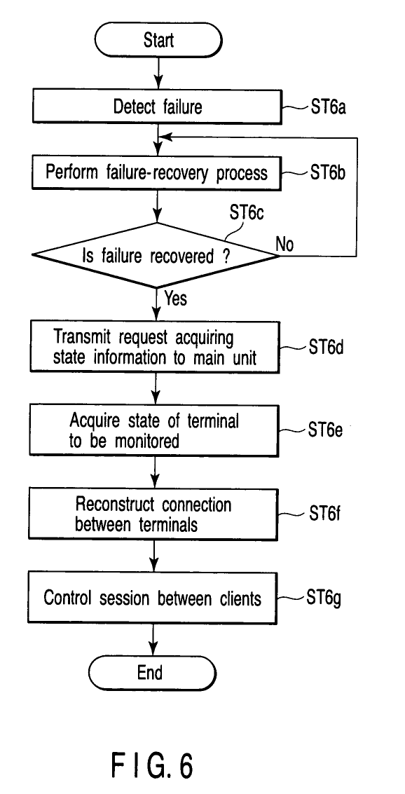

FIG. 6 is a flowchart showing a procedure for controlling the VCS server SV when a failure is detected and recovered.

When the VCS server SV detects a failure on a communication link between the VCS server SV and the main device BT (block ST6a), it performs a failure-recovery process (block STb) to determine whether the failure is recovered or not (block ST6c). If the failure is not recovered (No), the VCS server SV repeats the process of block ST6b until the failure is recovered.

On the other hand, if the failure is recovered (Yes), the VCS server SV establishes a communication link between the VCS server SV and the main device BT through the LAN 1. Then, the VCS server SV supplies the main device BT with a request acquiring state information of the extension terminals T11 to T1i to be monitored through the communication link (block ST6d). This request includes identification information (DN, node ID) of extension terminals T11 to T1i to be monitored.

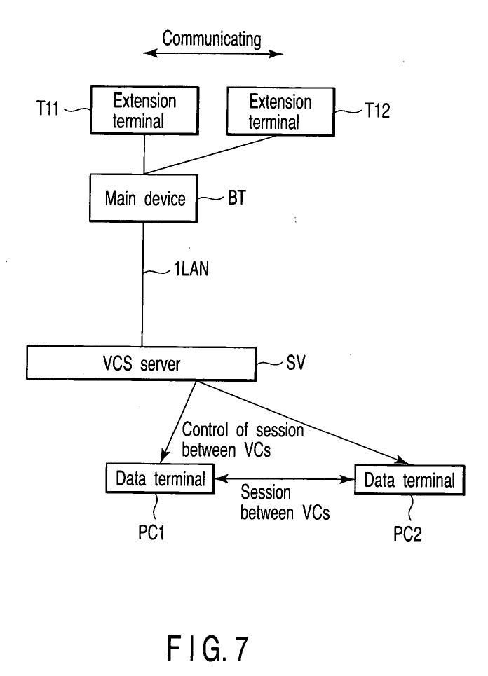

Upon receiving the state information from the main device BT (block ST6e), the VCS server SV analyzes the state information to determine that the users of the extension terminals T11 and T12 are communicating each other as shown in FIG. 7 (block ST6f) and establish a session between the data terminals PC1 and PC2 associated with the extension terminals T11 and T12 (block ST6g).

As described above, in the VCS server according to the embodiment of the present invention, when a failure occurs on the communication link between the VCS server and the main device BT, a failure-recovery process is performed. When the failure is recovered, a connection between the VCS server SV and the main device BT is automatically restored to acquire state information regarding the operations of the extension terminals T11 to T1i to be monitored from the main device BT. The state information is analyzed. When a call is made between the extension terminals T11 and T12 of the extension terminals T11 to T1i, a session is established between the data terminals PC1 and PC2 associated with the extension terminals T11 and T12, without receiving any new call information event indicating that a call is made between the extension terminals from the main device BT.

Even though a failure occurs, the VCS server SV can quickly establish a session between the data terminals PC1 and PC2 associated with the extension terminals T11 and T12 if a call is made between the extension terminals T11 and T12, without waiting for a restoration operation of a serviceperson or a call information event from the main device BT after the failure is recovered.

In the foregoing embodiment, when a failure is not recovered by one recovery process, the VCS server SV repeats the recovery process. Whatever failure occurs, the failure is not left for a long time but can be recovered with reliability.

In the foregoing embodiment, when a failure is recovered, the VCS server SV quickly sends out a request acquiring state information to the main device BT. The VCS server SV can obtain state information about the extension terminals T11 to T1i in real time after the failure is recovered.

The present invention is not limited to the above embodiment. In the embodiment, for example, the VCS server SV periodically transmits a monitor signal to the main device BT, and monitors whether it can receive a response signal from the main device BT to thereby detect whether a failure occurs. However, the VCS server SV can monitor whether it can receive a signal that is periodically transmitted from the main device BT to thereby detect whether a failure occurs.

Various modifications can be made to the configuration and type of the VCS server, the type of the telephone exchange (which is not limited to the main device but can be a PBX), the type of the internal terminals, the type of the data terminals, the contents stored in the tables, the method of controlling a session between the data terminals, the method of detecting and recovering a failure and the like, without departing from the spirit or scope of the subject matter of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A server apparatus which receives call information indicative of a call connection state of a plurality of telephone terminals from a telephone exchange apparatus that performs an exchange process between the plurality of telephone terminals, and associates data communication of data terminals associated with the plurality of telephone terminals with the call connection state, comprising:
a detector which detects a failure of communication between the telephone exchange apparatus and the server apparatus;
a restoring unit which restores a connection between the telephone exchange apparatus and the server apparatus by recovering the failure based on a detection result of the detector;
an acquiring unit which acquires state information regarding an operation of the plurality of telephone terminals from the telephone exchange, after the connection between the telephone exchange and the server apparatus is restored; and
a controller which performs data communication between first and second data terminals associated with first and second telephone terminals between which a call is made, based on the state information acquired by the acquiring unit.

2. The server apparatus according to claim 1, wherein the detector periodically transmits a signal to the telephone exchange apparatus and receives a response signal to determine that the failure has occurred, when the response signal is cut off.

3. The server apparatus according to claim 1, wherein the restoring unit repeats recovering the failure until the failure is recovered.

4. The server apparatus according to claim 1, wherein the acquiring unit sends out a request acquiring the state information to the telephone exchange and receives the state information from the telephone exchange apparatus in response to the request.
